(19) United States
(12) Patent Application Publication
(10) Pub. No.: US 2004/0234655 A1
(43) Pub. Date: Nov. 25, 2004

(54) Method for device for producing a casing of a larger length for foodstuff, particularly for sausages

(76) Inventors: Michael Hackner, Crailsheim (DE); Hartmut Bretschneider, Breittenbrunn (DE)

Correspondence Address: Horst M Kasper, 13 Forest Drive, Warren, NJ, 07059, US

(21) Appl. No.: 10/478,336

(22) PCT Filed: May 18, 2002
(86) PCT No.: PCT/EP02/05504

(30) Foreign Application Priority Data
May 19, 2001 (DE) 101 24 720.6
Sep. 18, 2001 (DE) 101 45 870.3

(51) Int. Cl. A21D 13/00

(52) U.S. Cl. 426/138

(57) ABSTRACT

The invention relates to a method for producing a casing of a larger length for foodstuffs, particularly for sausages. Said casing is comprised of a number of casing sections, which contain collagens, while using a mandrel onto which a first casing section is slid followed by a second casing section, whereby the facing end areas of both casing sections overlap on the mandrel thus resulting in the formation of an overlapping area of casing sections on which heat and pressure are temporarily applied to at least partially weld the casing sections to one another in the overlapping area. The overlapping area is positioned on a deformable expanding body, which is placed inside the casing sections and whose diameter can be enlarged from an initial diameter up to a final diameter. The expanding body is enlarged form its initial diameter to its final diameter before or during the welding process whereby resulting in enlarging the diameter of the overlapping area as well. The expanding body is permitted to return it its initial diameter upon completion of welding process.

### TECHNICAL REALM

The invention relates to a process for the production of a casing with a longer length for foodstuffs, especially for sausages, said casing comprising a plurality of individual casing sections made of intestines, which contain collagen, such as natural intestines or synthetic intestines containing collagen, using a mandrel onto which a first casing section is pushed and onto which a subsequent second casing section is likewise pushed in such a way that the end areas of the two casing sections facing each other overlap on the mandrel, thus forming an overlapping area of casing sections, whereby heat and pressure are simultaneously applied for some time to the overlapping area of two casing sections in such a way that the casing sections in the overlapping area are at least partially fused together, according to the generic part of claim 1. By the same token, the invention relates to a device for carrying out the process according to the generic part of claim 11.

### STATE OF THE ART

Particularly in meat-processing plants or in the meat industry, casings or intestines, for example, natural or synthetic intestines, are needed for the production of sausages whereby, for purposes of efficient manufacturing, to the extent possible, they should be present in the form of endless material or at least in longer lengths. Special natural intestines are normally only available in shorter lengths, which impairs efficient manufacturing.

German patent DE 679 748 discloses a process for the production of long sausage casings which is based on the technique of inserting the end pieces of intestines into each other and then sewing or gluing them together, which involves a considerable amount of work and time.

German patent DE 30 29 808 C2 relates to a process for positioning on a shared sleeve several natural intestine sections into which meat is to be filled. Here, the intestine sections are slipped over the sleeve in such a way that two consecutive intestine sections overlap. The end of the first intestine section is inserted into the beginning of the second, the end of the second into the beginning of the third, etc., so that a kind of continuous intestine is created. The individual intestine sections, however, are not joined to each other here.

German patent DE 10017172.9 proposes a process for the production of a casing with a longer length for foodstuffs, especially for sausages. A plurality of individual casing sections made of natural intestines containing collagen are pushed onto a mandrel in such a way that a first casing section is pushed onto the mandrel and a subsequent second casing section is likewise pushed onto the mandrel, so that the end areas of the two casing sections facing each other overlap on the mandrel, thus forming an overlapping area of casing sections. Heat and pressure are simultaneously applied for some time to this overlapping area of the two casing sections in such a way that the casing sections in the overlapping area are at least partially fused together. However, it has been found that this fusing technique results in a casing section that is shriveled after the fusing and that consequently has a perceptibly smaller diameter than the rest of the casing. When such an intestine with shriveled casing sections is filled with sausage filling, the result is conspicuously shriveled sections, something which at the very least impairs the appearance of the sausages.

German utility model DE 298 22 243.4 U discloses a flat material strip made of plastic that is very pliable in the crosswise and lengthwise directions and that serves as a carrier to be loaded with intestine sections. When the carrier is deformed out of its plane for proper use as a carrier of natural intestine sections, it is then bent out of the plane by means of a holding pipe along the lengthwise axis to form a surrounding element. For this purpose, the front end of the carrier is clamped onto the holding pipe by means of a semispherical hollow clamping bush. Beyond this clamping bush, the intestine sections are slid over the holding pipe so that the clamping bush serves as a guide for the leading end of each intestine section. As the natural intestine sections continue to be slipped onto the holding pipe, the carrier is shaped by the holding pipe to form a surrounding element onto which the intestine sections are slipped.

### TECHNICAL OBJECTIVE

The objective of the invention is to provide a process that, in an efficient manner, allows the production of a continuous sequence of sections that are securely joined to each other and made up of a plurality or numerous individual casing sections that can be sections of natural intestine, whereby even after the joining by means of heat and under pressure, the casing sections that are fused to each other are to have a uniform diameter that should be the same as the diameter of the joined casing sections.

### DISCLOSURE OF THE INVENTION AND ITS ADVANTAGES

This objective is achieved by a process for the production of a casing with a longer length for foodstuffs, especially for sausages, said casing comprising a plurality of individual casing sections made of intestines, which contain collagen, such as natural intestines or synthetic intestines containing collagen, using a mandrel onto which a first casing section is pushed and onto which a subsequent second casing section is likewise pushed in such a way that the end areas of the two casing sections facing each other overlap on the mandrel, thus forming an overlapping area of casing sections, whereby heat and pressure are simultaneously applied for some time to the overlapping area of the two casing sections in such a way that the casing sections in the overlapping area are at least partially fused together, characterized in that the overlapping area of the two casing sections is positioned onto a deformable expansion element that surrounds the mandrel like a ring, that is made of an elastically deformable material, that is located inside the casing sections and that can be enlarged in terms of its outer diameter from an initial diameter to a final diameter, whereby the expansion element is enlarged from its initial diameter to its final diameter before or during the fusing procedure of the overlapping area so that the diameter of the overlapping area is likewise enlarged, and after the fusing procedure, the expansion element returns to its initial diameter.

In an embodiment of the process, the diameter of the expansion element is changed pneumatically or hydraulically by feeding in or releasing compressed air or water into or out of the expansion element. The water or compressed air can advantageously be fed in through the interior of the mandrel. However, the expansion element can also be mechanically expanded by means of a mechanical expansion mechanism.

In a preferred embodiment of the process, the inner surface of the ring jaw is heated up during the fusing procedure to a temperature between 100° C. and 200° C. [212° F. and 392° F.]. An air pressure preferably between 2 and 6 bar is applied to the expansion element during the fusing procedure. The fusing duration is preferably between 3 seconds and 20 seconds.

In an especially advantageous embodiment of the process, the initial diameter, the final diameter, the fusing duration, the temperature of the inner surface during the fusing procedure and the air pressure applied to the expansion element are all selected in such a way that, after the fusing procedure, the diameter of the overlapping area in the unloaded state diverges by less than 5% from the diameter of the casing sections in the unloaded state.

In another embodiment of the process according to the invention, aside from the compressed air, water is separately fed through the mandrel all the way to the end of the mandrel onto which the casing sections are pushed, said water entering the inside of the casing section that is just about to be pushed onto the mandrel. The constant wetting of the mandrel with water ensures that the intestine sections can be easily slipped over the mandrel.

The process according to the invention has the advantage that, in an efficient manner, it allows the production of a continuous sequence of sections that are firmly joined to each other and made up of a plurality or numerous individual casing sections that can be sections of natural intestine or else synthetic intestine by means of heat and under pressure, whereby the double-layered sections of the overlapping areas have the same or virtually the same diameter as the casing sections themselves. As a result, during the stuffing of the casing with a food mass such as sausage filling, no sections with different diameters are formed; the casing is useable over its entire length.

The objective is also achieved by a device for the production of a casing with a longer length for foodstuffs, especially for sausages, said casing comprising a plurality of individual casing sections made of intestines, which contain collagen, such as natural intestines or synthetic intestines containing collagen, comprising a mandrel onto which a first casing section is pushed and onto which a subsequent second casing section is likewise pushed in such a way that the end areas of the two casing sections facing each other overlap on the mandrel, thus forming an overlapping area of casing sections, whereby heat and pressure can be simultaneously applied for some time to the overlapping area of the two casing sections in such a way that the casing sections in the overlapping area are at least partially fused together, characterized in that the mandrel is surrounded like a ring by a deformable expansion element that is made of an elastically deformable material, that is located inside the casing sections and that can be enlarged in terms of its outer diameter from an initial diameter to a final diameter.

The expansion element preferably consists of an elastically expandable material that absorbs mechanical tensile stress when the expansion element is enlarged. However, the expansion element can also be, for example, an expandable articulated link element, whereby the individual articulated links themselves are not expandable.

In a preferred embodiment of the invention, the diameter of the expansion element can be changed pneumatically or hydraulically by feeding in or releasing compressed air or water into or out of the expansion element.

The expansion element can be a closed hose ring and its outer diameter can be changed pneumatically or hydraulically by feeding in or releasing water or compressed air into or out of the hose ring.

The expansion element can also be a ring that surrounds the mandrel like a belt, having an inner surface facing the mandrel and an outer surface facing away from the mandrel which is pressure-tight on the edges located on the mandrel, whereby the outer diameter is changed by feeding in or releasing water or compressed air into or out of the area between the mandrel and the inner surface of the expansion element.

In a preferred embodiment of the invention, the mandrel has a pipe piece and a sealing sleeve as well as a sleeve positioned between the pipe piece and the sealing sleeve, each of which are part of the mandrel and are arranged next to each other in such a way that their axes coincide with the axis of the mandrel, whereby the expansion element between the sleeve and the pipe piece on the one hand, and between the sleeve and the sealing sleeve on the other hand, is clamped along its edges so as to be pressure-tight all around.

The sleeve can be made, for example, of heat-resistant plastic. In a preferred embodiment of the invention, the sleeve is made of heat-insulating material.

In another preferred embodiment, the mandrel has an outer pipe in which an inner pipe is secured, whereby the interstice between the outer pipe and the inner pipe serves as a feed line for compressed air for changing the diameter of the expansion element, while the inner pipe serves for the separate feed of water into the inside of the casing section that is to be pushed onto the mandrel.

The sleeve can have a transverse air channel that opens into the lateral surface of said sleeve and an air channel that communicates with said transverse air channel and that runs in the axial direction, while the pipe piece can have an air channel that runs over the entire length of the pipe piece in the axial direction of the pipe piece and that communicates with the air channel so that compressed air can be fed from the interstice between the outer pipe and the inner pipe via the air channels and the transverse air channel into the area between the mandrel and the inner surface of the expansion element.

The end of the mandrel facing the casing section that is to be pushed onto the mandrel can advantageously be formed as an essentially conical hollow tip whose base faces away from the casing section that is about to be pushed onto the mandrel and whose axis coincides with the axis of the mandrel, whereby the hollow tip has an axial bore in its tip that communicates with the inner pipe.

Advantageously, the overlapping area can be surrounded during the fusing process by a heated ring jaw that clamps around it like a ring and that has an inner surface—essentially describing a hollow cylinder—facing the overlapping area that serves as a compression and heating surface for applying heat and pressure onto the overlapping area, whereby the diameter of the hollow cylinder is identical to the final diameter. The ring jaw can be made up of at least two separate heated clamping jaws that lie flush, which, after the fusing procedure, can each be moved or swiveled apart in different directions. The timing of the feeding of the compressed air, of the moving of the clamping jaws and of the releasing of the compressed air can all be coordinated by means of a control aggregate.

The ring jaw can advantageously have pressure compensation channels that are each open at both ends and that each have one end that opens into the inner surface of the ring jaw.

The inner surface of the ring jaw can also have pressure compensation grooves that run parallel to the inner surface and that open up with at least one end into an edge of the inner surface.

The pressure compensation channels or pressure compensation grooves facilitate the conforming of the overlapping area to the inner surface of the ring jaw and, after the fusing procedure, facilitate the removal of the overlapping area from said ring jaw.

According to a variant of the process, the surfaces of the clamping jaws facing the overlapping area each have a plurality of openings of suction channels that run inside the clamping jaws and that are connected to a negative pressure pump or vacuum pump by means of which steam is sucked out of the hollow cylinder via the suction channels and via the openings.

According to a preferred embodiment of the invention, a plurality of suction channels pass through the ring jaw and they each open up into the inner surface of the ring jaw, where a negative pressure prevails that is generated by at least one negative pressure pump or vacuum pump. The ends of the suction channels facing away from the inner surface of the ring jaw can each open up into a shared suction collecting line, whose one end is closed and whose other end is connected to the negative pressure pump or vacuum pump. In particular, each suction channel can consist of a main channel and of a plurality of side channels, said side channels branching off from the main channel and opening up into the inner surface of the ring jaw. The negative pressure pump or vacuum pump can be a water jet pump or a Venturi nozzle operated with compressed air or water.

Brief description of the drawing in which the following is shown:

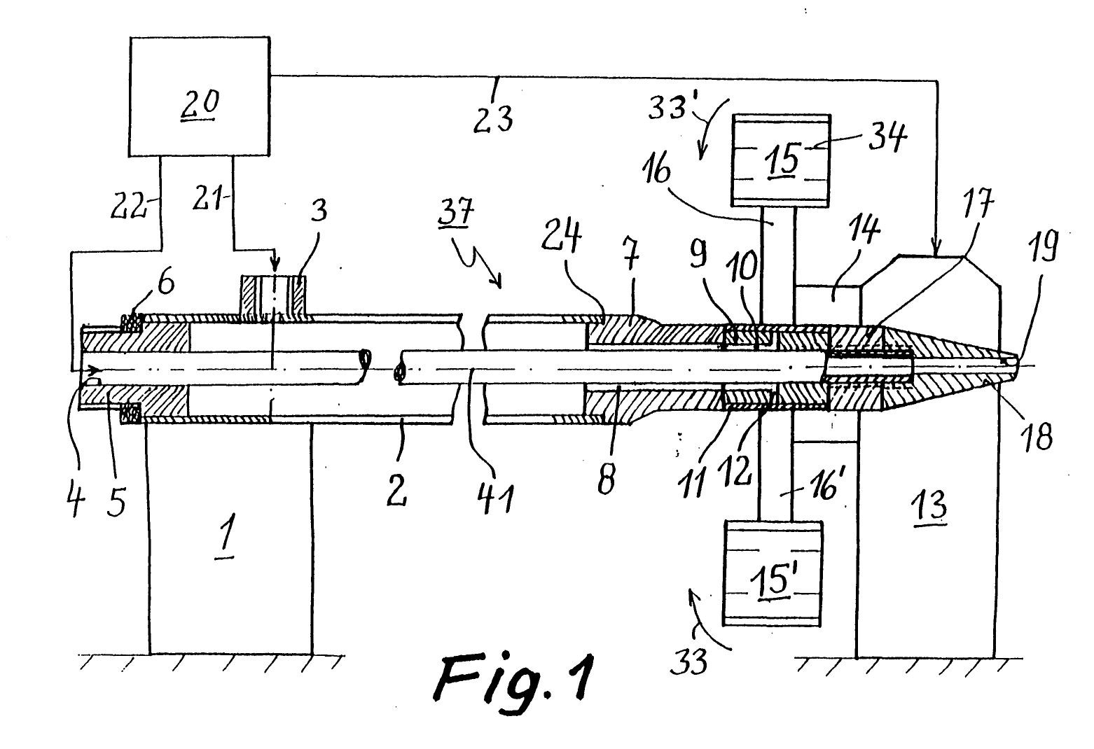

FIG. 1 a schematic simplified view of a device for carrying out the process according to the invention,

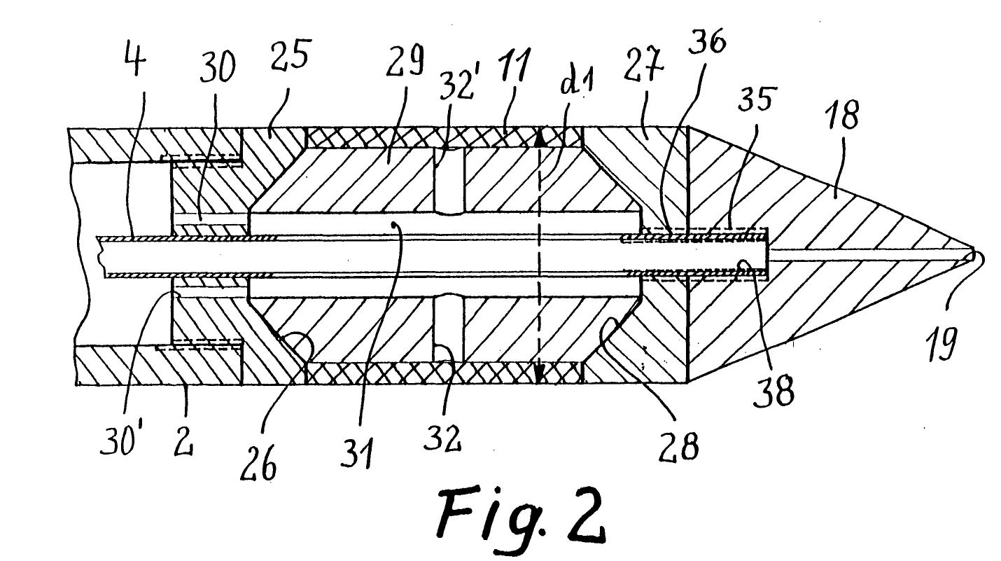

FIG. 2 an example of a technical embodiment of an expansion element in a lengthwise section in the state of its initial diameter d1 in the resting position,

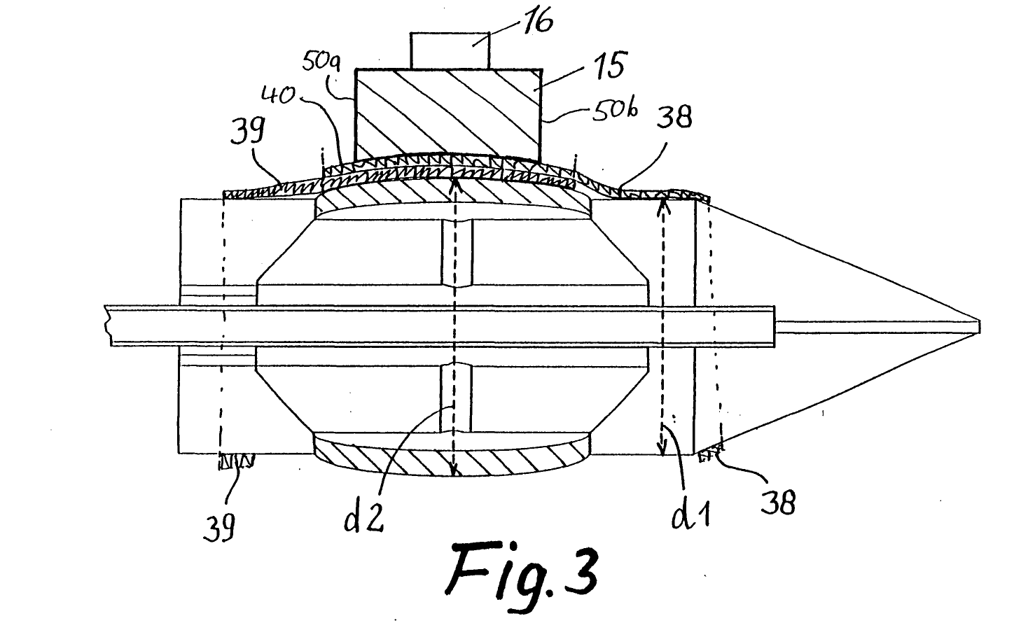

FIG. 3 the expansion element of FIG. 2 in the state of its final diameter d2 in the operating position during the fusing procedure of the overlapping area of the casing sections,

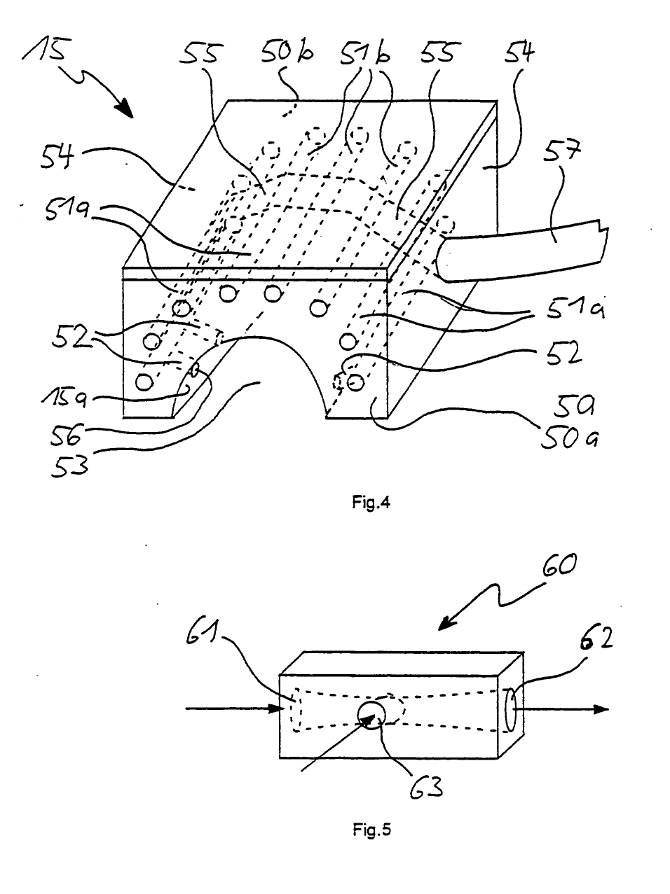

FIG. 4 a schematic representation of an embodiment of a clamping jaw that is part of a ring jaw and that serves to apply pressure and heat onto the overlapping area of FIG. 3, and

FIG. 5 a schematic representation of a Venturi nozzle that serves to suction steam out of the interior of the ring jaw.

The figures show preferred embodiments of the invention, whereby in the figures, the same parts are designated with the same reference numerals.

According to the figures, the process is carried out by a device that fundamentally consists of an elongated, cylindrical mandrel 37 which is arranged in the area of its back end on a carrier 1 and is oriented horizontally; the remaining part of the mandrel 37 is self-supporting. The mandrel 37 preferably consists of a cylindrical outer pipe 2, preferably made of stainless steel, that has an air inlet in its lateral surface. Compressed air can be fed through this air inlet 3 into the outer pipe 2 from a source of compressed air (not shown here) through a compressed air line 21 that has an electrically controllable compressed air valve (not shown here). In the rear end of the outer pipe 2 (shown on the left-hand of FIG. 1), there is a sealing cuff 5 that has a central passage bore through which an inner pipe 4 projects into the outer pipe 2 and extends along the lengthwise axis 41 of the outer pipe 2. The rear end of the sealing cuff 5 is once again sealed vis-à-vis the outer pipe 2 by means of a sealing ring 6 so that the interior of the outer pipe 2 is sealed pressure-tight vis-à-vis the sealing cuff 5 as well as vis-à-vis the passage of the inner pipe 4 by the sealing cuff 5. At the end of the inner pipe 4 in the sealing cuff 5, there is a water feed line which is symbolized by a line 22 in which an electrically controllable shut-off valve can likewise be arranged.

A likewise cylindrical pipe piece 7 is placed pressure-free, for example, glued or screwed and glued, on the other end of the outer pipe 2, which has air channels 8 running parallel to the lengthwise axis 41 and extending through the entire length of the pipe piece 7. The pipe piece 7 also has a centered passage opening through which the inner pipe 4 passes or else the pipe piece 7 rests on the inner pipe 4. This pipe piece 7 is followed by a sleeve 9 that has a smaller outer diameter than the abutting end of the pipe piece 7; the inner pipe 4 likewise passes through this sleeve 9 or else the sleeve 9 rests on the inner pipe 4. The sleeve 9 likewise has air channels 10 that correspond to the air channels 8 of the pipe piece 7. On the circumference, the sleeve has a plurality of radially oriented transverse air channels 12 that are connected to the air channels 10 so that air can reach the lateral surface of the sleeve 9. The sleeve 9 preferably consists of a heat-resistant plastic such as Teflon and preferably has a relatively high heat conductivity.

On the sleeve 9, there is a sleeve-shaped expansion element 11 whose wall consists of an elastically deformable plastic material having a high heat resistance. The expansion element 11 covers the outlet openings of the transverse air channels 12 distributed along a circumferential line so as to hermetically seal them. The sleeve 9 is followed by a sealing sleeve 17 that is screwed, for example, by means of an internal thread onto an outer thread of the inner pipe 4. By means of this sealing sleeve 17, the sleeve 9 and also the expansion element 11 can be securely clamped onto the pipe piece 7, as a result of which a good air-tightness of the sealing sleeve 17 vis-à-vis the expansion element is achieved. The inner pipe 4 also penetrates the sealing sleeve 17 which is followed by a hollow tip 18 that is, for example, screwed onto the end of the inner pipe 4. The hollow tip 18 has a bore which opens up at the end of the hollow tip 18. In this manner, water can be fed through the inner pipe 4, which can be seen in FIG. 1.

In the area of the sleeve 9 and of the expansion element 11 situated on said sleeve 9, there are two electrically heated clamping jaws 15, 15′, each arranged on one of the swiveling arms 16, 16′ that are attached onto a flange 14 of a stand part 13 so that they can be moved by means of an electric motor (not shown here). The clamping jaws 15, 15′ are arranged with respect to the sleeve 9 in such a way that they can be swiveled onto the sleeve 9 in order to assume their working position, FIG. 3, which is indicated by the curved swiveling arrows 33, 33′ in FIG. 1. The clamping jaws each have a semi-cylindrical recess that is open towards the expansion element 11 and whose diameter is larger than the diameter d1, FIG. 2, of the expansion element 11 in its resting position. In this orientation, after the clamping jaws 15, 15′ have been moved towards each other, they can practically completely grip the expansion element 11. In their resting position, the clamping jaws 15, 15′ are at a distance from the sleeve 9, which is shown in FIG. 1.

A control aggregate 20 is provided that regulates the work sequence of the device. For this purpose, using an air valve control line 21, the control aggregate 20 can open and close a valve (not shown here) in the air valve control line 21. Likewise, using a water valve control line, the control aggregate 20 can open and close a water valve (not shown here). By the same token, an electric clamping jaw control line 23 leads from the control aggregate 20 to the electric motor for purposes of opening and closing the clamping jaws 15, 15′.

The mode of operation of the device is described below, whereby reference is also made to FIG. 3.

FIG. 3 shows a longitudinal section of two casing sections 39 and 38 containing collagen that overlap with each other and that are to be joined to each other, whereby the left-hand casing section 39, which is the first one to be pushed onto the mandrel 37, is arranged in such a way that its right-hand end rests on the expansion element 11 and surrounds it. An end area of another second casing section 38 is pushed onto the mandrel 37 or onto the expansion element 11 in such a way that the end areas of the two casing sections 38, 39 overlap, namely, precisely over the expansion element 1. In this manner, an overlapping area 40 is formed over and around the expansion element 11, which is shown in FIG. 3. Water is fed through the inner pipe while the casing sections 38, 39 are pushed on so that the casing sections can be easily pushed onto the mandrel 37.

When the two ends of the two casing sections 38, 39 are now positioned as shown in FIG. 3, the clamping jaws 15, 15′ are heated and moved towards each other until they touch or almost touch each other, and between them, they enclose the expansion element 11 along with the overlapping area 40. Now, compressed air is fed into the outer pipe 2 via the air inlet 3, as a result of which the elastic expansion element 11 expands along its circumference, until it assumes its enlarged final diameter d2, which is determined by the inner distance of the clamping jaws 15, 15′ from the initial diameter d1 of the expansion element 11 in its resting position; this can also be derived from FIG. 3. The final diameter d2 of the expansion element 11 during the fusing is thus larger than the initial diameter d1 of the expansion element 11 in its resting position. When the expansion element 11 distends, of course, the overlapping area 40 of the end areas of the two casing sections 38, 39 are likewise stretched, so that the overlapping area 40 is fused while in a stretched state.

The joining of the two end areas of the two casing sections 38, 39 with each other is carried out in that the overlapping area 40 is heated and exposed to pressure, whereby the counterpressure is generated by the air pressure inside the expansion element 11. The air pressure applied to the expansion element 11 here lies between 2 bar and 6 bar, preferably 4 bar. The end areas of the two casing sections 38, 39 are joined by denaturing the collagen material either of the natural intestine or of the synthetic intestine.

The temperature of the clamping jaws 15, 15′ and/or the time duration during which the jaws remain in the working position are selected in such a way that, in the overlapping area 40, the end areas of the casing sections 38, 39 are joined or fused, namely, without damaging and without burning the material containing collagen. Specifically, the time and temperature can be selected via the control aggregate 20 in such a way that, even taking the existing moisture into account, the crosswise bonds between the collagen filaments are briefly eliminated and then reconstituted during the cooling phase, namely, precisely between the end areas of the overlapping area 40. The temperature of the jaws 15, 15′ and the treatment time are established by means of temperature sensors in such a way that the temperature in the material of the overlapping area 40 lies approximately in the range of up to 200° C. [392° F.], preferably from 100° C. to 150° C. [212° F. to 302° F.]. The fusing time of the overlapping area 40 is between 3 seconds and 20 seconds and depends on the temperature. As already explained, the sleeve 9 preferably consists of a thermally insulating material so that only the clamping jaws 15, 15′ are heated up. By the same token, the expansion element 11 is made of a highly heat-resistant plastic material that is suitable for contact with foodstuffs.

As soon as the clamping jaws 15, 15′ are moved back into their resting position and the compressed air is released from the expansion element 11, the latter moves back into its old resting position having the initial diameter d1, whereby the diameter of the overlapping area 40 becomes smaller as well; after the fusing, the overlapping area shrinks in terms of its diameter. The preceding stretching of the expansion element via the selected working pressure, the time duration of the fusing and the fusing temperature of the clamping jaws 15, 15′ are all selected in such a way that the diameter of the fused overlapping area 40 corresponds to the diameter of the casing sections 38, 39 as such, so that no diameter differences occur in the continuous casing that is continually pushed onto the mandrel 37 during the production process.

FIG. 2 shows a technical embodiment of an expansion element 11 on an air diffusing sleeve 29 in a longitudinal section in the state of its initial diameter d1 in the resting position. The air diffusing sleeve 29 has an air guide 31 along the lengthwise axis 41 into which radially oriented transverse air channels 32, 32′ distributed on the circumference open up. The air diffusing sleeve 29 has conically shaped ends at both ends, which are accommodated in matching recesses 26, 28 of clamping elements 25, 27, whereby the clamping element 25 on the left-hand side in FIG. 2 has air channels 30, 31 running along the lengthwise axis 41. Since the air diffusing sleeve 29 is preferably made of a plastic material that, in addition to the thermal insulation, also has a certain elasticity, a very good air tightness of the air diffusing sleeve 29 can be achieved when the hollow tip 18 is screwed onto the inner pipe 4.

FIG. 4 shows a schematic representation of an embodiment of the clamping jaw 15 of FIG. 1. The clamping jaw 15 has a semi-cylindrical recess 53 that is open towards the expansion element and that is delineated by a semi-cylindrical inner wall 15a. Moreover, the clamping jaw 15 can be heated, which is not shown in FIG. 4. A pair of clamping jaws 15, 15′ of FIG. 1, as already explained above, serves to apply pressure and heat on the overlapping area 40 of FIG. 3, whereby the inner walls function as pressure and heating surfaces and, in the working position, said pair of clamping jaws 15, 15′ together forms a ring jaw that clamps around the overlapping area 40 like a ring during the fusing procedure. The two clamping jaws 15, 15′ are preferably configured identical to each other, whereby only the clamping jaw 15 is shown in FIG. 4.

A suction collecting line 55 runs essentially through the center of the clamping jaw 15, said suction collecting line running essentially crosswise to the lengthwise axis of the semi-cylindrical recess 53. A first group of main channels 51a extends from the suction collecting line 55 in the direction of the one front face 50a (located in the front in FIG. 4) of the clamping jaw 15 while a second group of main channels 51b extends in the direction of the other, opposite front face 50b (in the back and concealed in FIG. 4). All of the main channels 51a, 51b open up into the suction collecting line 55.

The suction collecting line 55 is closed at one end; with its other end, it opens up into one of the side surfaces 54 of the clamping jaw 15, where its becomes a pressure-tight suction line 57 that can be configured, for example, as a hose and that leads to the suction inlet of a negative pressure pump or vacuum pump (FIG. 5).

The main channels 51a, 51b run inside the clamping jaw 15 essentially parallel to each other and parallel to the lengthwise axis of the semi-cylindrical recess 53 over approximately half of the lengthwise extension of the clamping jaw 15, from the suction collecting line 55 all the way to the area of one of the front faces 50a, 50b (FIG. 3, FIG. 4) but without opening up there; rather, the main channels 51a, 51b are closed in the area of the front faces 50a, 50b. Preferably, the main channels 51 are arranged equidistantly around the recess 53, whereby the axes of the main channels 51 all run at the same distance to the inner wall 15a.

Several side channels 52 branch off from each main channel 51a, 51b and open up as openings 56 into the inner surface 15a of the clamping jaw 15. The openings 56 are preferably distributed uniformly over the inner surface 15a; for the sake of clarity, only a few of the side channels and their openings are shown in FIG. 4. In actual practice, their number can amount to several dozen.

Each main channel 51a, 51b, together with the side channels 52 that branch off from it, forms a so-called suction channel. Therefore, each of these suction channels consists of a main channel 51a, 51b and a plurality of side channels 52, as a result of which it has a plurality of inlets, namely, the openings 56 of the side channels into the inner surface 15a, and only one outlet, namely, the mouth of the main channel leading into the suction collecting line 55. The latter, in turn, leads to the suction inlet of the negative pressure pump or vacuum pump.

In this manner, according to the invention, steam that is formed during the application of pressure and heat onto the overlapping area 40 of FIG. 3 can be suctioned off over the entire surface via the openings 56, the side channels 52, the main channels 51, the suction collecting line 55, the hose 57 and the negative pressure pump or vacuum pump and led out of the hollow cylinder situated between the clamping jaws 15, 15′, i.e. out of the interior of the ring jaw, so that advantageously the detrimental influence of steam on the fusing process is eliminated.

FIG. 5 shows a schematic representation of a Venturi nozzle 60 that serves as a negative pressure pump for suctioning steam out of the interior of the ring jaw. The Venturi nozzle 60 of FIG. 5 has a drive inlet 61 that is preferably supplied with compressed air, a suction inlet 63 as well as an outlet 62. The suction inlet 63 is connected via the hose 57 to the suction collecting line 55. The suction action of the Venturi nozzle 60 is actuated by feeding compressed air into the drive inlet 61; a negative pressure is created in the suction inlet 63 in order to suction out the steam in the manner described above. Preferably, a negative pressure of approximately 1 bar is created at the suction inlet 63. A water jet pump can be used instead of the Venturi nozzle 60.

### COMMERCIAL APPLICABILITY

The invention can be employed commercially for the production of a continuous natural intestine casing for the production of foodstuffs, especially sausages.

The main figure is FIG. 3.

List of Reference Numerals

1 carrier

2 outer pipe

3 air inlet

4 inner pipe

5 sealing cuff

6 sealing ring

7 pipe piece

8, 10 air channels

9 sleeve

11 expansion element

12 transverse air channel

13 stand part

14 flange

15, 15′ clamping jaws

16, 16′ swiveling arms

17 sealing sleeve

18 hollow tip

19 bore

20 control aggregate

21 air valve control line

22 water valve control line

23 clamping jaw control line

24 strip clamp

25, 27 clamping element

26, 28 conical surrounding surfaces

29 air diffusing sleeve

30, 30′ air channels

31 air guide

32, 32′ transverse air channel

33, 33′ swiveling arrows

34 pressure compensation grooves

35, 36, 38 thread

37 mandrel

38, 39 casing sections

40 overlapping area

41 lengthwise axis

50a,b front, back of 17

51a, b main channels

52 side channels of 51

53 recess in 17

54 side surfaces of 17

55 suction collecting line

56 openings of 52

57 hose

60 negative pressure pump or vacuum pump

61 drive inlet of 60

62 outlet of 60

63 suction inlet of 60

d1 initial diameter of the expansion element

d2 final diameter of the expansion element

1. A process for the production of a casing with a longer length for foodstuffs, especially for sausages, said casing comprising a plurality of individual casing sections (38, 39) made of intestines, which contain collagen, such as natural intestines or synthetic intestines containing collagen, using a mandrel (37) onto which a first casing section (39) is pushed and onto which a subsequent second casing section (38) is likewise pushed in such a way that the end areas of the two casing sections (38, 39) facing each other overlap on the mandrel (37), thus forming an overlapping area (40) of casing sections (38, 39), whereby heat and pressure are simultaneously applied for some time to the overlapping area (40) of the two casing sections (38, 39) in such a way that the casing sections (38, 39) in the overlapping area (40) are at least partially fused together characterized in that
the overlapping area (40) of the two casing sections is positioned onto a deformable expansion element that surrounds the mandrel (37) like a ring, that is made of an elastically deformable material, that is located inside the casing sections and that can be enlarged in terms of its outer diameter from an initial diameter to a final diameter, whereby the expansion element is enlarged from its initial diameter to its final diameter before or during the fusing procedure of the overlapping area (40) so that the diameter of the overlapping area (40) is likewise enlarged, and after the fusing procedure, the expansion element returns to its initial diameter.

2. The process according to claim 1, characterized in that
the diameter of the expansion element (11) is changed pneumatically or hydraulically by feeding in or releasing compressed air or water into or out of the expansion element.

3. The process according to claim 1, characterized in that
the expansion element (11) is a closed hose ring and the outer diameter is changed by feeding in or releasing compressed air or water into or out of the hose ring.

4. The process according to claim 1, characterized in that
the expansion element (11) is a ring that surrounds the mandrel (37) like a belt, that has an inner surface facing the mandrel (37) and an outer surface facing away from the mandrel (37) and that is arranged pressure-tight on the edges of the mandrel (37), whereby the outer diameter is changed by feeding in or releasing water or compressed air into or out of the area between the mandrel and the inner surface of the expansion element.

5. The process according to claim 2, characterized in that
the overlapping area (40) is surrounded during the fusing process by a heated ring jaw that clamps around it like a ring and that has an inner surface, essentially describing a hollow cylinder, and facing the overlapping area (40) that serves as a compression and heating surface for applying heat and pressure onto the overlapping area, whereby the diameter of the hollow cylinder is identical to the final diameter (d2), whereby the ring jaw is assembled from at least two separate heated clamping jaws (15, 15′) so as to lie flush, which, after the fusing procedure, can each be moved or swiveled apart in different directions and the timing of the feeding of the compressed air, of the moving of the clamping jaws (15, 15′) and of the releasing of the compressed air are all coordinated by means of a control aggregate (20).

6. The process according to claim 5, characterized in that
the inner surface of the ring jaw is heated up during the fusing procedure to a temperature between 100° C. and 200° C. [212° F. and 392° F.].

7. The process according to one of claims 5 or 6, characterized in that
the surfaces of the clamping jaws (15, 15′) facing the overlapping area (40) each have a plurality of openings (56) of suction channels (51a, 51b, 52) that run inside the clamping jaws (15, 15′) and that are connected to a negative pressure pump or vacuum pump (60) by means of which steam is sucked out of the hollow cylinder via the suction channels (51a, 51b, 52) and via the openings (56).

8. The process according to one of claims 1 to 7, characterized in that
an air pressure between 2 and 6 bar is applied to the expansion element (11) during the fusing procedure.

9. The process according to one of claims 1 to 8, characterized in that
the fusing duration is between 3 seconds and 20 seconds.

10. The process according to one of claims 1 to 9, characterized in that
the initial diameter (d1), the final diameter (d2), the fusing duration, the temperature of the inner surface during the fusing procedure and the air pressure applied to the expansion element (11) are all selected in such a way that, after the fusing procedure, the diameter of the overlapping area in the unloaded state diverges by less than 5% from the diameter of the casing sections (38, 39) in the unloaded state.

11. The device for the production of a casing with a longer length for foodstuffs, especially for sausages, said casing comprising a plurality of individual casing sections (38, 39) made of intestines, which contain collagen, such as natural intestines or synthetic intestines containing collagen, using a mandrel (37) onto which a first casing section (39) is pushed and onto which a subsequent second casing section (38) is likewise pushed in such a way that the end areas of the two casing sections (38, 39) facing each other overlap on the mandrel (37), thus forming an overlapping area (40) of casing sections (38, 39), whereby heat and pressure are simultaneously applied for some time to the overlapping area (40) of the two casing sections (38, 39) in such a way that the casing sections (38, 39) are fused together in the overlapping area (40), at least partially, characterized in that
the mandrel is surrounded like a ring by a deformable expansion element that is made of an elastically deformable material, that is located inside the casing sections and that can be enlarged in terms of its outer diameter from an initial diameter to a final diameter.

12. The device according to claim 11, characterized in that
the expansion element (11) is a closed hose ring.

13. The device according to claim 11, characterized in that
the expansion element (11) is a ring that surrounds the mandrel (37) like a belt, that has an inner surface facing the mandrel (37) and an outer surface facing away from the mandrel (37) and that is arranged pressure-tight on the edges of the mandrel (37).

14. The device according to claim 12 or 13, characterized in that
the diameter of the expansion element (11) can be changed pneumatically or hydraulically by feeding in or releasing compressed air or water into or out of the expansion element.

15. The device according to claim 13, characterized in that
the mandrel (37) has a pipe piece (7) and a sealing sleeve (17) as well as a sleeve (9) located between the pipe piece (7) and the sealing sleeve (17), each of which are part of the mandrel (37) and are arranged next to each other in such a way that their axes (41) coincide with the axis of the mandrel (37), whereby the expansion element (11) between the sleeve (9) and the pipe piece (7) on the one hand, and between the sleeve (9) and the sealing sleeve (17) on the other hand, is clamped along its edges so as to be pressure-tight all around.

16. The device according to claim 15, characterized in that
the sleeve (9) is made of heat-resistant plastic.

17. The device according to claim 15 or 16, characterized in that
the sleeve (9) is made of thermally insulating material.

18. The device according to claim 11, characterized in that
the mandrel (37) has an outer pipe (2) in which an inner pipe (4) is secured, whereby the interstice between the outer pipe and the inner pipe (2, 4) serves as a feed line for compressed air for changing the diameter of the expansion element (11), while the inner pipe (4) serves for the separate feed of water into the inside of the casing section (38) that is to be pushed onto the mandrel (37).

19. The device according to claim 15 and 18, characterized in that
the sleeve (9) has a transverse air channel (12) that opens into its lateral surface and an air channel (10) that communicates with the former and that runs in the axial direction, while the pipe piece (7) can have an air channel (8) that runs over the entire length of the pipe piece (7) in the axial direction of the pipe piece (7) and that communicates with the air channel (10) so that compressed air can be fed from the interstice between the outer pipe (2) and the inner pipe (4) via the air channels (8, 10) and the transverse air channel (12) into the area between the mandrel and the inner surface of the expansion element (11).

20. The device according to claim 18, characterized in that
the end of the mandrel (37) facing the casing section (38) that is to be pushed onto the mandrel (37) can advantageously be formed by an essentially conical hollow tip (18) whose base surface faces away from the casing section (38) that is about to be pushed onto the mandrel (37) and whose axis coincides with the axis of the mandrel, whereby the hollow tip (18) has an axial bore (19) in its tip that communicates with the inner pipe (4).

21. The device according to claim 11, characterized in that
the overlapping area (40) is surrounded during the fusing process by a heated ring jaw that clamps around it like a ring and that has an inner surface, essentially describing a hollow cylinder, and facing the overlapping area (40) that serves as a compression and heating surface for applying heat and pressure onto the overlapping area, whereby the diameter of the hollow cylinder is identical to the final diameter (d2).

22. The device according to claim 21, characterized in that
the ring jaw is assembled from at least two separate heated clamping jaws (15, 15′) so as to lie flush, which, after the fusing procedure, can each be moved or swiveled apart in different directions.

23. The device according to claim 21 or 22, characterized in that
the ring jaw has pressure compensation channels that are each open at both ends and that each have one end that opens into the inner surface of the ring jaw.

24. The device according to claim 21 or 22, characterized in that
a plurality of suction channels (51a, 51b, 52) pass through the ring jaw and they each open up into the inner surface (15a) of the ring jaw, and in which a negative pressure prevails that is generated by at least one negative pressure pump or vacuum pump (60).

25. The device according to claim 24, characterized in that
the ends of the suction channels (51a, 51b, 52) facing away from the inner surface (15a) of the ring jaw can each open up into a shared suction collecting line (55), whose one end is closed and whose other end is connected to the negative pressure pump or vacuum pump (60).

26. The device according to claim 24 or 25, characterized in that
each suction channel consists of a main channel (51a, 51b) and of a plurality of side channels (52), said side channels (52) branching off from the main channel and opening up into the inner surface (15a) of the ring jaw.

27. The device according to one of claims 24 to 26, characterized in that
the negative pressure pump or vacuum pump is a water jet pump or a Venturi nozzle (60) operated with compressed air or water.

28. The device according to claim 22, characterized in that
the inner surface of the ring jaw has pressure compensation grooves (34) that run parallel to the inner surface and that open up with at least one end into an edge of the inner surface.

29. The device according to claims 14 and 24, characterized in that
the timing of the feeding of the compressed air, of the moving of the clamping jaws and of the releasing of the compressed air are all coordinated by means of a control aggregate.
